(19) United States
(12) Patent Application Publication
(10) Pub. No.: US 2022/0009577 A1
(43) Pub. Date: Jan. 13, 2022

(54) SAFE HORN

(71) Applicant: JAMES A. PATTAS, WEBSTER, WI (US)

(72) Inventor: JAMES A. PATTAS, WEBSTER, WI (US)

(21) Appl. No.: 16/923,308

(22) Filed: Jul. 8, 2020

(51) Int. Cl. B62J 3/10

(52) U.S. Cl. CPC B62J 3/10

(57) ABSTRACT

The present invention provides a horn or vehicle warning system that is operably accessible to the operator of a motorcycle without the need to release the grip when in use.

### BACKGROUND

Motorcycles and bikes are provided with handlebars for stabilization and use to maneuver the vehicles. The persistent advice to bikers is to use both hands on both sides of the handlebars for their safety and to ensure the smooth operation of their vehicle. Such advice is of key importance as bikes run on two wheels and small deviations and distractions can easily result in unstable operation, dislocation and accidents. Dislocations, or worse, accidents are prime issues that take away the fun of bike riding.

Large capacity motorcycles portend greater risks of injury than smaller bikes bring because of the horsepower it provides and the likelihood that riders of such bikes may engage in manners that would bring forth such risks, even if unwittingly. In any given instance, there may be need to toot the horn on the bike to alert others and provide more room for the bike to maneuver. Most bikes have their horn button set in a manner that a rider would have to move his/her hand inward to reach the button. The act of moving or releasing the grip of the arm to reach the horn button makes for some level of instability, thus increasing the likelihood of bad outcomes, such as losing balance, failing to horn, pressing the wrong button or worse, falling.

From the foregoing and more, it will be appreciated that what is needed in the art is a system or fix that allows the reach to the horn button without necessarily leaving or releasing from the grip in any manner for its intended use or purpose. Such system is disclosed and claimed herein.

### SUMMARY

In one embodiment, the present invention provides a horn system for a motorcycle that provides an easy reach to the button wherein such reach is sufficient to be operable without the need to release the grip from the handlebar.

An embodiment of the present invention provides a horn or warning mechanism that is operably accessible in a position distal to the central frame of the handlebar that an operator of the motorcycle may activate on demand without the need to release the grip of the handlebar.

In another embodiment of the present invention, the handlebar grip includes a formed notch or button that is built into the handlebar and provides easy access without the untimely activation when in operation of the motorcycle

### BRIEF DESCRIPTION OF THE DRAWINGS

FIG. 1 illustrates a handlebar with pressure petals according to the present invention.

FIG. 2 illustrates a handlebar with pressure contact ring and housing according to the present invention.

FIG. 3 illustrates a handlebar with finger and thumb activation buttons according to the present invention.

FIG. 4 illustrates a handlebar with push-type triggers according to the present invention.

### DETAILED DESCRIPTION

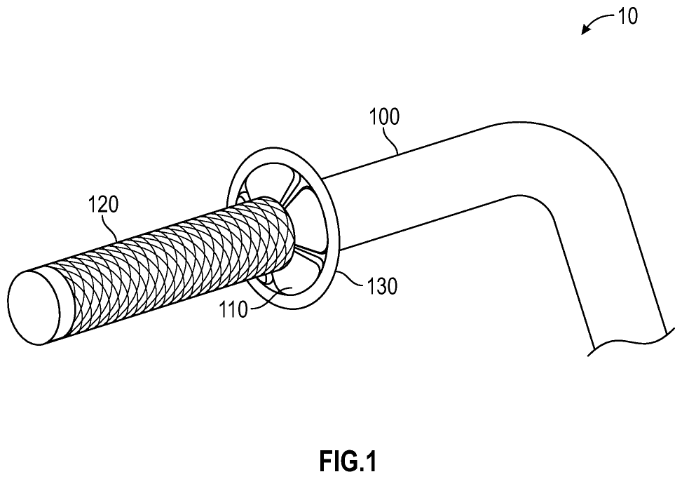

Referring to FIG. 1, a handlebar grip 100 is provided in accordance with the present invention wherein said handlebar fitted with at least a pressure petal 110 that is positioned proximate to the hand grip 120 of a motorcycle or bicycle. Motorcycle handlebar grips come in a variety of models and forms, but the novel instance of the present invention has been lacking or not thought of. The present invention introduces a proximate link between the handlebar grip and horn or other instrument for warning others in a manner that the driver of the motorcycle would not necessarily lose control of the grip to activate the horn or such warning instrument. In many instances, the grip of the handlebar is available in forms that may be fanciful or otherwise as the market demands. The present invention may be incorporated into the after-market sleeve for the grip or formed to incorporated separately.

As note in FIG. 1, the pressure petal or such operably adapted fixture provides for the easy activation of the horn or warning system without releasing the grip or the unnecessary adjustment in order to reach the provided buttons for such horn. In accordance with the present invention, the handlebar grip 100 is preferably or adaptably formed to fit with the manufacturer provided handlebar. The present invention adapts the provided handlebar grip to most motorcycles wherein the instruments and buttons are extended further distal from the grip towards the body of the motorcycle as against any other setup. The provision of a petal pressure-type button system makes for easy control and enables the driver or operator of the motorcycle to easily or effortlessly activate such buttons for the needed warning action. The petal system is further provided to prevent unintended activation with the introduction of some underlying sensor (not shown) that would not be activated by a mere touching of the petal system. The activation and the underlying electronics making such activation reasonably safe from unintended activation may include a buffer layer that may be presented between the buttons and the electronics that connect to the warning system—such that only intended actions provide activation. The operator of the motorcycle would necessarily tap, press or push such petal button to activate the horn.

Most motorcycles have other buttons that may be useful to electronically start the engine, activate turn signals, control light bean positions and the like. The handlebar grip of the present invention would operationally not interfere with the other functions that are present on the handlebar. Although the left-hand side of the handlebar is shown, this adaptation may be introduced to the right-hand side of the handlebar for similar effective purpose. The handlebar grip of the present invention may be formed from material that may be adaptable to form and fit into the handlebar of a motorcycle. Such material may include or be selected from rubber, polyvinyl chloride or other form-fitting and durable material that may be durable for use as well as provide some vibration dampening for the operator. In some cases, the material may be made of leather that is padded for use. Notwithstanding the material usable for the handlebar grip of the present invention, the positioning of the horn is preferably fitted to provide ease and access to the operator of the motorcycle without unnecessarily losing grip of the handle to activate it.

Referring again to FIG. 1, the present invention may include an edge 130 or such form-fitting separation that may be adaptable to include electronics or wiring that may be made to operably fit any wiring that is needed to make useful the provision of an activation system for the horn of the present invention.

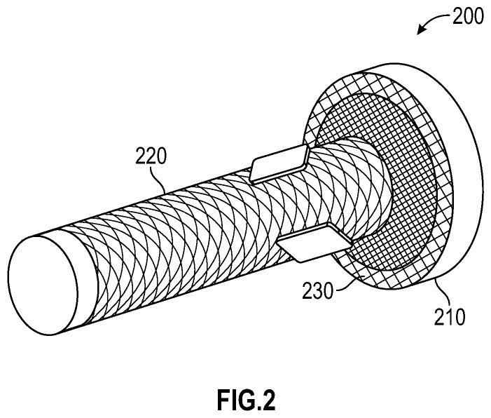

Referring now to FIG. 2, a handlebar grip 200 is provided in accordance with the present invention wherein said handlebar fitted with at least a pressure ring 210 that is positioned proximate to the hand grip 220 of a motorcycle or bicycle. Motorcycle handlebar grips come in a variety of models and forms, but the novel instance of the present invention has been lacking or not thought of. The present invention introduces a proximate link between the handlebar grip and horn or other instrument for warning others in a manner that the driver of the motorcycle would not necessarily lose control of the grip to activate the horn or such warning instrument.

As noted in FIG. 2, the pressure ring or such operably adapted fixture provides for the easy activation of the horn or warning system without releasing the grip or the unnecessary adjustment in order to reach the provided buttons for such horn. In accordance with the present invention, the handlebar grip 200 is preferably or adaptably formed to fit with the manufacturer provided handlebar. The present invention adapts the provided handlebar grip to most motorcycles wherein the instruments and buttons are extended further distal from the grip towards the body of the motorcycle as against any other setup. The provision of a petal pressure-type button system makes for easy control and enables the driver or operator of the motorcycle to easily or effortlessly activate such buttons for the needed warning action. The ring system is further provided to prevent unintended activation with the introduction of some underlying sensor (not shown) that would not be activated by a mere touching of the petal system. The activation and the underlying electronics making such activation reasonably safe from unintended activation may include a buffer layer that may be presented between the buttons and the electronics that connect to the warning system —such that only intended actions provide activation. The operator of the motorcycle would necessarily tap, press or push such petal button to activate the horn.

Most motorcycles have other buttons that may be useful to electronically start the engine, activate turn signals, control light bean positions and the like. The handlebar grip of the present invention would operationally not interfere with the other functions that are present on the handlebar. Although the left-hand side of the handlebar is shown, this adaptation may be introduced to the right-hand side of the handlebar for similar effective purpose. The handlebar grip of the present invention may be formed from material that may be adaptable to form and fit into the handlebar of a motorcycle. Such material may include or be selected from rubber, polyvinyl chloride or other form-fitting and durable material that may be durable for use as well as provide some vibration dampening for the operator. In some cases, the material may be made of leather that is padded for use. Notwithstanding the material usable for the handlebar grip of the present invention, the positioning of the horn is preferably fitted to provide ease and access to the operator of the motorcycle without unnecessarily losing grip of the handle to activate it.

Referring again to FIG. 2, the present invention may include an edge 230 or such form-fitting separation that may be adaptable to include electronics or wiring that may be made to operably fit any wiring that is needed to make useful the provision of an activation system for the horn of the present invention.

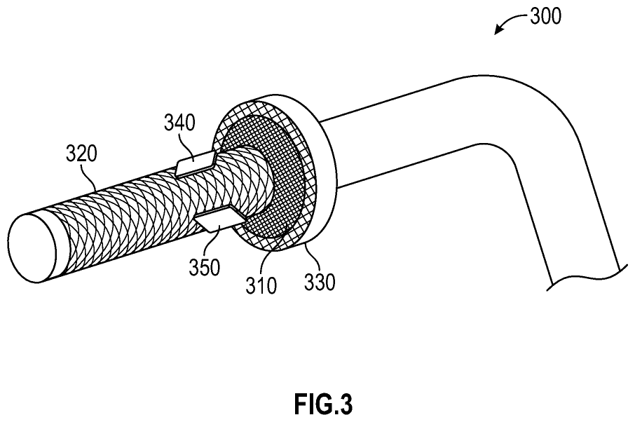

Referring to FIG. 3, a handlebar grip 300 is provided in accordance with the present invention wherein said handlebar fitted with at least a pressure belt 310 that is positioned proximate to the hand grip 320 of a motorcycle or bicycle. The motorcycle handlebar grips in FIG. 3 may also include buttons 340, 350 that are included in the hand grip as part of the novel handlebar grip 320. The presentation of the grip and buttons of the invention introduces buttons that are readily accessible to the operator on the handlebar grip. It is reasonable to include adaptations that operably make for the comfort and rugged stability needed to keep the horn or warning mechanism of the present invention suitable to keep the easily reachable horn of the present invention. In many instances, the grip of the handlebar is available in forms that may be fanciful or otherwise as the market demands. The present invention may be incorporated into the after-market sleeve for the grip or formed to incorporated separately.

As noted in FIG. 3, the pressure ring, notch or button or such operably adapted fixture provides for the easy activation of the horn or warning system without releasing the grip or the unnecessary adjustment in order to reach the provided buttons for such horn. In accordance with the present invention, the handlebar grip 300 is preferably or adaptably formed to fit with the manufacturer provided handlebar. The present invention adapts the provided handlebar grip to most motorcycles wherein the instruments and buttons are extended further distal from the grip towards the body of the motorcycle as against any other setup. The provision of a pressure-type button system makes for easy control and enables the driver or operator of the motorcycle to easily or effortlessly activate such buttons for the needed warning action. The petal system is further provided to prevent unintended activation with the introduction of some underlying sensor (not shown) that would not be activated by a mere touching of the petal system. The activation and the underlying electronics making such activation reasonably safe from unintended activation may include a buffer layer that may be presented between the buttons and the electronics that connect to the warning system—such that only intended actions provide activation. The operator of the motorcycle would necessarily tap, press or push such petal button to activate the horn.

Most motorcycles have other buttons that may be useful to electronically start the engine, activate turn signals, control light bean positions and the like. The handlebar grip of the present invention would operationally not interfere with the other functions that are present on the handlebar. Although the left-hand side of the handlebar is shown, this adaptation may be introduced to the right-hand side of the handlebar for similar effective purpose. The handlebar grip of the present invention may be formed from material that may be adaptable to form and fit into the handlebar of a motorcycle. Such material may include or be selected from rubber, polyvinyl chloride or other form-fitting and durable material that may be durable for use as well as provide some vibration dampening for the operator. In some cases, the material may be made of leather that is padded for use. Notwithstanding the material usable for the handlebar grip of the present invention, the positioning of the horn is preferably fitted to provide ease and access to the operator of the motorcycle without unnecessarily losing grip of the handle to activate it.

Referring again to FIG. 3, the present invention may include an edge 330 or such form-fitting separation that may be adaptable to include electronics or wiring that may be made to operably fit any wiring that is needed to make useful the provision of an activation system for the horn of the present invention.

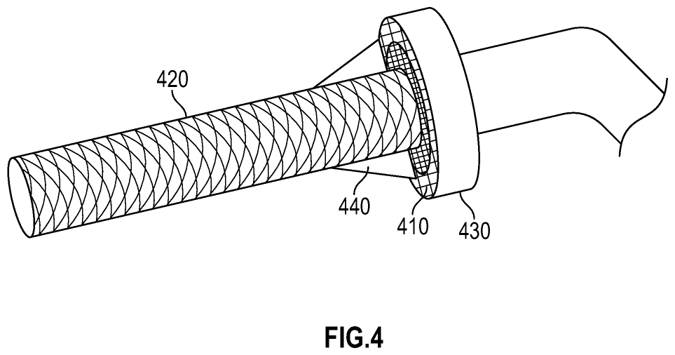

Referring to FIG. 4, a handlebar grip 400 is provided in accordance with the present invention wherein said handlebar fitted with at least a cover for switches or connections 410 that is positioned proximate to the hand grip 420 of a motorcycle or bicycle. The motorcycle handlebar grips in FIG. 4 may also include triggers or trigger activation buttons 440, 450 that are included in the hand grip as part of the novel handlebar grip 420. The presentation of the grip and buttons of the invention introduces buttons that are readily accessible to the operator on the handlebar grip. It is reasonable to include adaptations that operably make for the comfort and rugged stability needed to keep the horn or warning mechanism of the present invention suitable to keep the easily reachable horn of the present invention. In many instances, the grip of the handlebar is available in forms that may be fanciful or otherwise as the market demands. The present invention may be incorporated into the after-market sleeve for the grip or formed to incorporated separately.

As noted in FIG. 4, the cover assembly, notch or button or such operably adapted fixture provides for the easy activation of the horn or warning system without releasing the grip or the unnecessary adjustment in order to reach the provided buttons for such horn. In accordance with the present invention, the handlebar grip 420 is preferably or adaptably formed to fit with the manufacturer provided handlebar. The present invention adapts the provided handlebar grip to most motorcycles wherein the instruments and buttons are extended further distal from the grip towards the body of the motorcycle as against any other setup. The provision of a trigger activation button or such activation system makes for easy control and enables the driver or operator of the motorcycle to easily or effortlessly activate such buttons for the needed warning action. The trigger activation system may be conditioned on both sides being activated to prevent unintended activation with the introduction of some underlying sensor (not shown) that would not be activated by a mere touching of the trigger activation system. The activation and the underlying electronics making such activation reasonably safe from unintended activation may include a buffer layer that may be presented between the buttons and the electronics that connect to the warning system—such that only intended actions provide activation. The operator of the motorcycle would necessarily tap, press or push such trigger button to activate the horn.

Referring again to FIG. 4, the present invention may include an edge 430 or such form-fitting separation that may be adaptable to include electronics or wiring that may be made to operably fit any wiring that is needed to make useful the provision of an activation system for the horn of the present invention.

Having thus described the preferred embodiments of the present invention, those of skill in the art will readily appreciate that the teachings found herein may be applied to yet other embodiments within the scope of the claims hereto attached. The complete disclosure of all patents, patent documents, and publications are incorporated herein by reference as if individually incorporated.

What is claimed:

1. A motorcycle horn or warning system, comprising:
a handlebar grip, wherein said grip further comprises at least a pressure petal that is accessible to the handlebar, and
further wherein the petal has a wiring mechanism incorporated therein for the activation of the horn or warning system;
wherein the pressure petal is readily accessible to an operator of the motorcycle without releasing the grip of the handlebar in a manner distal from the center of the handlebar.

2. The horn or waning system of claim 1, wherein the handlebar grip is made of rubber.

3. The horn or warning system of claim 1, wherein the handlebar grip has a button or notch in the handlebar.

4. A motorcycle horn or warning system, comprising:
a handlebar grip, wherein said grip further comprises at least a trigger activation button that is accessible to the handlebar, and
further wherein the petal has a wiring mechanism incorporated therein for the activation of the horn or warning system;
wherein the trigger activation button is readily accessible to an operator of the motorcycle without releasing the grip of the handlebar in a manner distal from the center of the handlebar.

5. The horn or waning system of claim 4, wherein the trigger activation button includes a buffer pressure system to prevent undue activation.

6. The horn or warning system of claim 4, wherein the handlebar grip has a secondary button to provide for safe activation.

7. A motorcycle horn or warning system, comprising:
a handlebar grip, wherein said grip further comprises at least a pressure ring that is accessible to the handlebar, and
further wherein the pressure ring has a wiring mechanism incorporated therein for the activation of the horn or warning system;
wherein the pressure ring is readily accessible to an operator of the motorcycle without releasing the grip of the handlebar in a manner distal from the center of the handlebar.

8. The horn or waning system of claim 7, wherein the handlebar grip is made of rubber.
